(19) United States
(12) Patent Application Publication
(10) Pub. No.: US 2012/0119043 A1
(43) Pub. Date: May 17, 2012

(54) LOCKING MECHANISM FOR TRAYS

(75) Inventor: James J. Rataiczak, III, Chesterland, OH (US)

(73) Assignee: Fasteners For Retail, Inc.

(21) Appl. No.: 12/947,278

(22) Filed: Nov. 16, 2010

(51) Int. Cl. F16M 13/02

(52) U.S. Cl. 248/218.4

(57) ABSTRACT

A bracket assembly for coupling a merchandise display member to an associated upright support member includes a bracket member and a lock moveably mounted to the bracket member. The bracket member includes a first body having a first generally planar surface and a first tooth extending from the first body. The first tooth is adapted to selectively seat in a slot in the associated upright support member. The lock includes a second body having a generally planar surface positioned adjacent to the first planar surface. The second tooth extends from the second body. The second tooth is adapted to simultaneously seat in a slot in the associated upright support member. A handle portion selectively moves the lock relative to the bracket member.

### BACKGROUND

The instant disclosure relates generally to bracket holders. More particularly, the present disclosure relates to a bracket and lock assembly that prevents a mounted shelf or tray from moving in relation to an upright support member when an upward force is applied to the tray.

Store shelving systems are used in retail establishments, such as discount department stores, grocery stores, and the like, for displaying merchandise. These shelving assemblies include vertically spaced shelves or trays that are removeably mounted to upright support members. Uniformly spaced slots receive brackets secured to the shelf for coupling the shelf to the uprights. These brackets include a tooth that engages a selected mounting slot formed in the upright. The tooth includes a hook- shaped projection that seats firmly onto a lower edge of the select slot. The projection prevents a downwardly applied force from moving the shelf relative to the upright. Although the shelf or tray is adapted to support the merchandise on it and not react to a downwardly applied force, the bracket can disengage from its slot when the tray receives an upwardly applied force.

Some attempts have been made to construct brackets that support both upwardly and downwardly applied forces. A variety of bracket designs include a locking tab that occupies a slot in the upright. In a first type, the locking tab springs inwardly toward an unoccupied portion of a slot that is made available after the hook-shaped projection locks into position. The locking tab is included on a steel, flexible strip that is attached to the bracket.

Still in other designs, the bracket acts as a cam on a locking tab when the tooth is lowered into a secure engagement with the slot of the upright. Accordingly, a biased movement of the locking tab is related to a movement of the bracket member. However, with these designs, a vertical position of the tray is not easily adjusted. The bracket requires a suitable tool, such as a screw driver, to depress the locking tab. Other designs also require a tool to selectively bend the locking tab into position.

It would be desirable to have a locking mechanism which can be retrofitted to an existing upright so as to inhibit tray movement via an upwardly applied force. At the same time, the bracket should be easily accessible to store personnel to allow for a vertical readjustment of the shelf in a prompt and efficient manner.

Accordingly, there is a need for a new and improved locking mechanism which overcomes certain difficulties with prior art designs while providing better and more advantageous overall results.

### BRIEF DESCRIPTION

In one embodiment, the present disclosure relates to a bracket assembly for coupling an associated merchandise display member to an associated upright support member. The bracket assembly includes a bracket member and a lock moveably mounted to the bracket member. The bracket member includes a first body having a first generally planar surface and a first tooth extending from the first body. The first tooth is adapted to selectively seat in a slot in the associated upright support member. The lock includes a second body having a generally planar surface positioned adjacent to the first planar surface. A second tooth extends from the second body. The second tooth is adapted to simultaneously seat in a slot in the associated upright support member. A handle portion selectively moves the lock relative to the bracket member.

According to another embodiment of the present disclosure, the bracket assembly for coupling a merchandise display member to an associated upright includes a bracket member and a lock adapted to move relative to the bracket member. The bracket member includes a first tooth adapted to occupy a first portion of a slot in the associated upright. The lock includes a second tooth adapted to occupy a second portion of the slot in the associated upright. The first and second teeth seat respectively against opposed edges of the slot in the associated upright such that the first and second teeth prevent a removal of the merchandise display member from the associated upright.

According to a further embodiment of the present disclosure, a bracket assembly is provided for coupling a merchandise display member to an associated upright support member. The bracket assembly includes a bracket member having a first tooth that extends outwardly from a first body. The first tooth includes a first notch where the first tooth meets the first body. The bracket assembly further includes a lock that is moveable relative to the bracket member. The lock includes a second tooth which extends outwardly from a second body. The second tooth includes a contact surface at a terminal end of the second tooth. The first tooth occupies a first slot in the associated upright and the second tooth occupies a second adjacent slot in the associated upright. The second tooth is adapted to prevent lifting of the merchandise display member from the associated upright.

### BRIEF DESCRIPTION OF THE DRAWINGS

The present disclosure may take physical form in certain parts and arrangements of parts, several embodiments of which will be described in detail in this specification and illustrated in the accompanying drawings which form a part hereof and wherein:

FIG. 1 is a front perspective view of a bracket assembly according to a first embodiment of the present disclosure, as mounted to an upright support member for supporting a shelf or tray;

FIG. 2 is a front perspective view of the bracket assembly of FIG. 1, as removed from another type of support;

FIG. 3 is a rear perspective view of the bracket assembly of FIG. 1, as mounted to the support of FIG. 2;

FIG. 4 is a side view of the bracket assembly of FIG. 1, as mounted to the support of FIG. 2;

FIG. 5 is an exploded perspective view of the bracket assembly of FIG. 1;

FIG. 6 is a side view of a bracket assembly according to a second embodiment of the present disclosure, as mounted to a first type of upright support member, in a locked position;

FIG. 7 is a side view of the bracket assembly of FIG. 6, as mounted to the first upright, in an unlocked position;

FIG. 8 is a side view of the bracket assembly of FIG. 6, as mounted to a second type of upright support member, in a locked position; and,

FIG. 9 is a side view of the bracket assembly of FIG. 8, as mounted to the second type of upright in an unlocked position.

### DETAILED DESCRIPTION

It should be understood that the description and drawings herein are merely illustrative and that various modifications and changes can be made in the structures disclosed, without departing from the present disclosure. It should also be appreciated that the various identified components of the bracket assembly designs discussed herein are merely terms of art, and that these may vary from one manufacturer to another. Such terms should not be deemed to limit the present disclosure.

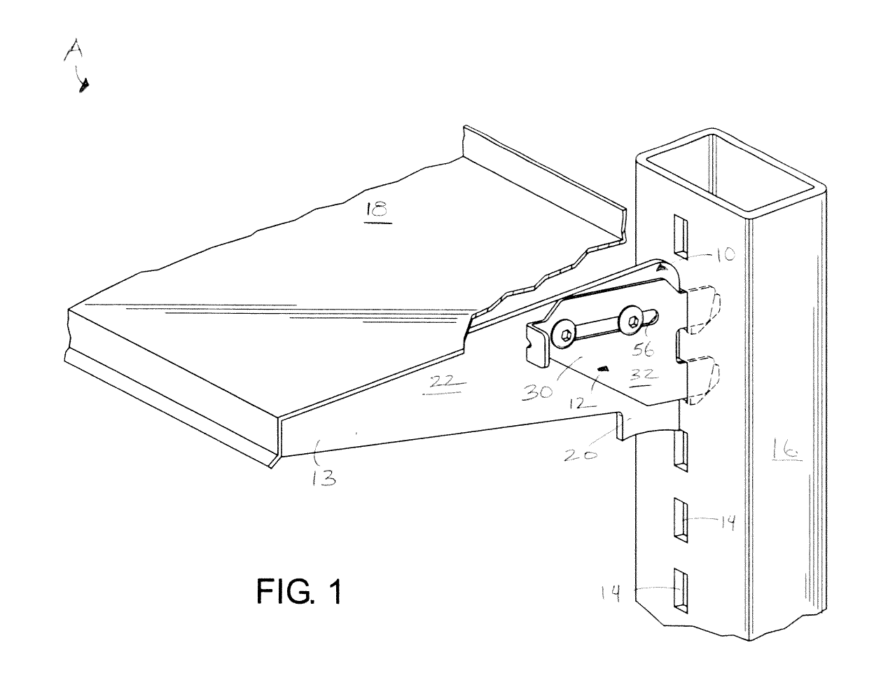

Referring now to the drawings, FIG. 1 illustrates a first embodiment of a bracket assembly according to the present disclosure. More particularly, the bracket assembly A includes a bracket member 10 and a lock member 12, both mounted to a side wall 13 of a merchandise display member 18 such as a shelf or tray. In one embodiment, the bracket member 10 can be of one piece with a shelf side wall. In another embodiment, the bracket member 10 can be secured to the shelf side wall 13, such as by fasteners or welding. It should be appreciated that bracket assemblies are provided for both side walls of the shelf 18, although only one is shown in the Figures. In still other embodiments, the bracket assemblies can be separate components onto which a display member is mounted. Portions of the bracket assembly A are adapted to be received into at least one slot 14 of an associated support member 16, which, in this embodiment, is vertically oriented and often referred to as an “upright”.

In one embodiment, a store display shelving system includes at least two spaced apart uprights 16 that are mounted to a wall or similar support (not shown). In this embodiment, uniformly spaced slots 14 are formed along a longitudinal extent of each upright 16. Corresponding slots 14 formed in a pair of uprights 16 each receive a respective bracket member 10 for supporting the merchandise display member 18 (variously referred to as a tray or a shelf). The tray 18 is horizontally oriented and extends in a plane between the pair of spaced uprights. The tray or merchandise display member extends outwardly from the uprights at a selected vertical position. The vertical position of the tray 18 is adjustable by reinserting the bracket members 10 into a different pair of vertically spaced corresponding slots 14.

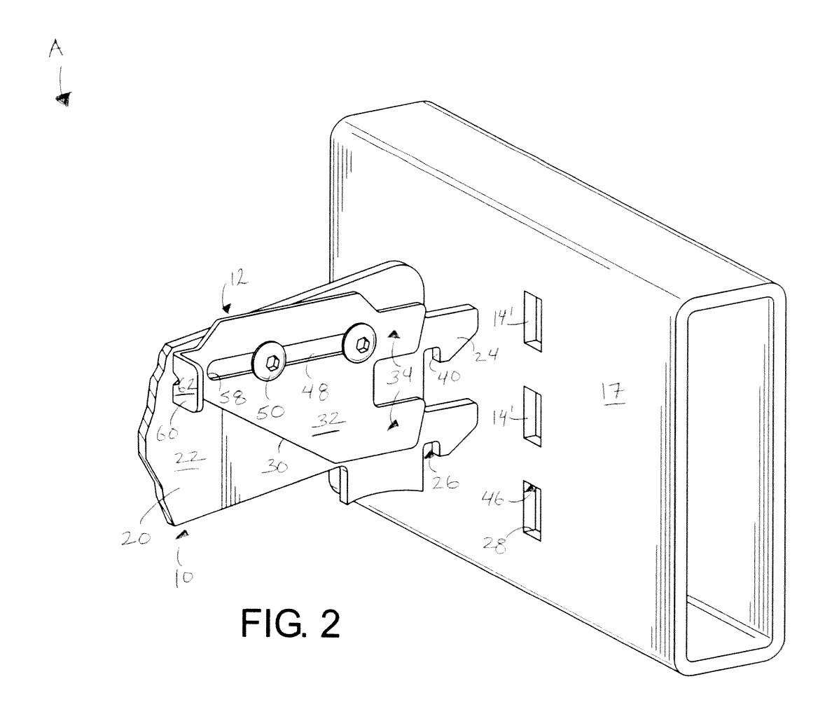

With reference to FIG. 2, the lock member 12 of the bracket assembly A of the present disclosure can be retrofitted to shelves for use with several types of retail support members whether these are vertically oriented as in FIG. 1 or horizontally oriented as in FIG. 2. In this embodiment, a horizontally oriented support 17 is shown. Thus, both bracket assemblies, located on opposed side walls of a shelf or tray, are mounted to the same support 17, unlike the uprights of FIG. 1. The bracket member 10 as illustrated includes a generally planar body 20. There is no limitation made herein, however, as to the dimensions of the body 20. Other embodiments are contemplated, such as, for example, a generally planar surface 22 portion on a three dimensional body. The bracket member 10 further includes at least one projection, tooth or hook 24 (hereinafter referred to as a “bracket tooth”) protruding outwardly or away from the body 20. The illustrated embodiment includes two spaced apart bracket teeth 24. The bracket teeth 24 extend beyond a terminal end of the body 20. It should be appreciated that in various embodiments more or less than two teeth can be employed for each bracket.

With continued reference to FIG. 2, the hook-shaped projection or tooth 24 is defined by a notch 26 (synonymously referred to as an “inward step”) which separates the bracket tooth 24 from the remaining portion of the bracket. The notch 26 is formed where a lower edge of the bracket tooth 24 meets the terminal edge of the body 20. In the illustrated embodiment, the notch 26 generally includes dimensions equivalent to a slot depth. In this manner, the bracket tooth 24 may seat firmly on a lower edge 28 of a slot 14′ of the support 17.

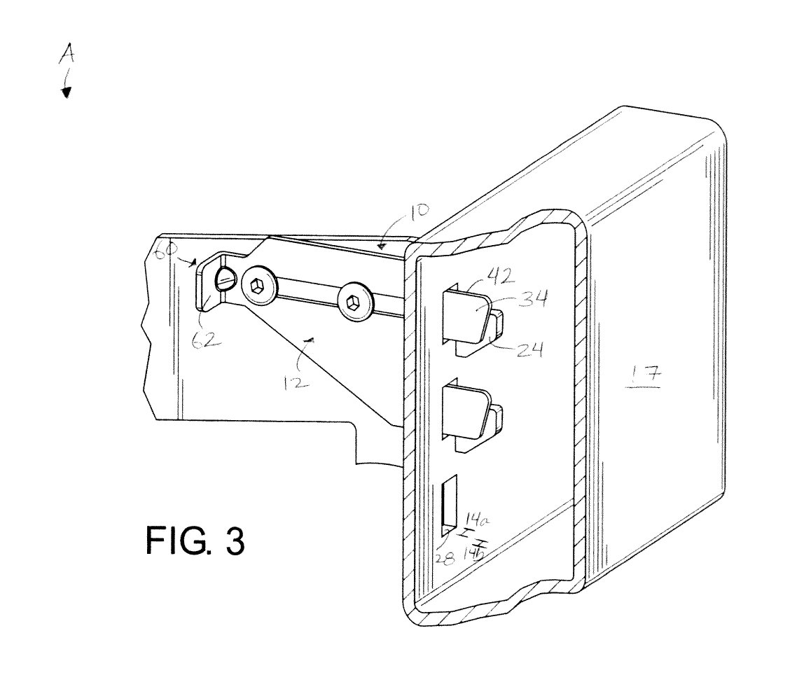

With continued reference to FIG. 2, the lock 12 includes a locking body 30. In the embodiment illustrated, the locking body 30 is generally planar. However, multiple shapes or geometries are contemplated. The locking body 30 similarly includes a generally planar surface 32. The generally planar surfaces 22, 32 of the bracket member 10 and the lock 12 are situated in adjacent relationship. The lock 12 further includes at least one lock tooth 34 extending outwardly from the lock body 32. The embodiment illustrated in FIGS. 1-5 includes two spaced apart lock teeth 34. Each lock tooth 34 includes a length that extends beyond a depth of the slot 14′ when the lock 12 is selectively placed in a locking position (see FIG. 3). Each lock tooth 34 further includes a height that is generally equivalent to a height of the slot 14. While two teeth 34 are shown in the embodiment illustrated, it should be appreciated that more or less than that number can be employed. Moreover, the number of locking teeth does not necessarily need to match the number of teeth provided on the bracket.

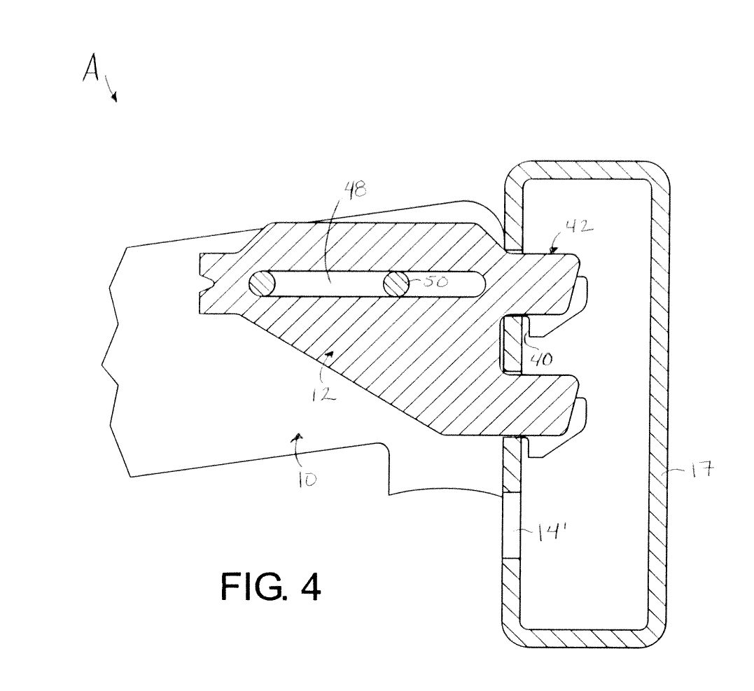

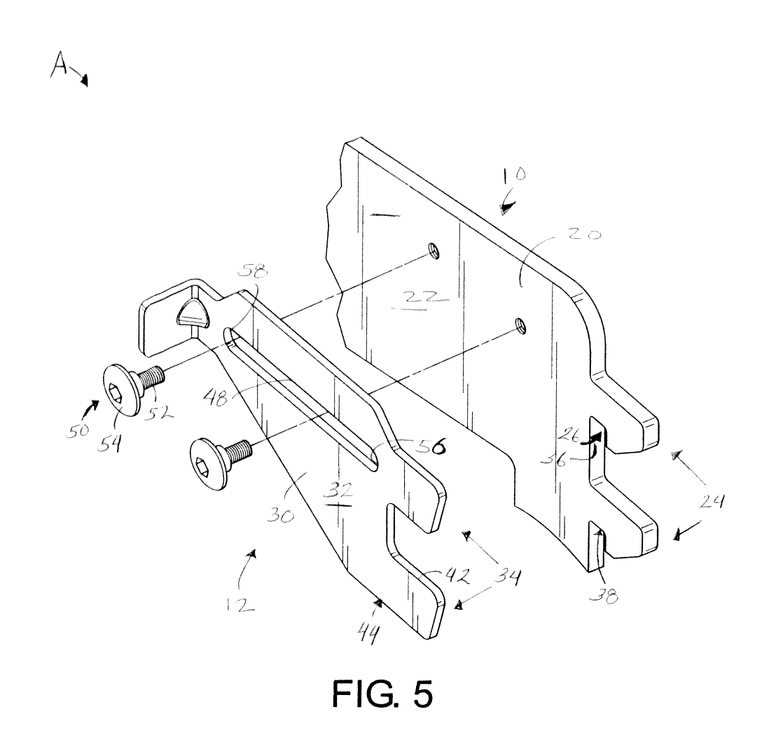

With reference to FIGS. 3 and 4, one aspect of the present disclosure is a design that firmly positions the tray 18 on the shelving system. More particularly, the combination of the bracket tooth 24 and the lock tooth 34 prevent inward, outward, upward, and downward movements of the tray 18 with applied forces. The tray 18 is secure once both of the bracket member 10 and the lock 12 engage the support 17. As can be viewed in the figures, the notch 26 of the bracket member 10 is defined by a first edge 36 (FIG. 5), a second edge 38, and a third edge 40 (FIG. 2). The first edge 36 is located on a terminal edge portion of the body 20. This first edge 36 (and/or terminal edge of the body 20) prevents inward (i.e., forward) movement of the tray 18 when the bracket is seated in the slot 14. The third edge 40, opposite the first edge 36, similarly prevents outward (i.e., reverse) movement of the tray 18. The third edge 40 acts as a positive stop member.

With continued reference to FIGS. 3 and 5, the lock tooth 34 includes a top edge 42 and a bottom edge 44. The top edge 42 generally abuts an upper edge portion 46 (FIG. 2) of the slot 14′ when the lock 12 is in a locking position. This top edge 42 acts as a positive stop when a force is applied upwardly to the tray 18. In this manner, the tray 18 will not lift in reaction to the upwardly applied force. Similarly, the bottom edge 44 generally abuts the lower edge portion 28 of the slot 14 when the lock 12 is in the locking position. In this manner, the bottom edge 44 can act in conjunction with the teeth 24 as a positive stop when a force is applied downwardly to the tray 18.

One aspect of the present disclosure is a bracket assembly A that is capable of being selectively moved between a locked position (FIGS. 1, 3 and 4) and an unlocked position (FIG. 2). Put another way, the lock 12 is moveable in relation to the bracket member 10. In the discussed embodiment, the lock 12 is slideable against the bracket member 10.

With reference to FIG. 5, features of the bracket assembly A are adapted to enable a sliding movement of the lock 12 against the bracket member 10. To this end, a first one of the lock 12 and bracket member 10 includes an elongate slot 48. The elongate slot 48 acts as a sliding track. The second one of the lock 12 and the bracket member 10 includes at least one pin 50. The pin 50 extends through the elongate slot 48 for guiding the movement of the lock 12.

With continued reference to FIG. 5, the illustrated embodiment includes the elongate slot 48 formed through the lock 12. Two pins 50 extend outwardly from the bracket member 10 toward the lock 12. These pins 50 are rigidly attached to the bracket member 10. A neck 52 of the pins extends through the elongate slot 48. A head 54 of pins 50 maintains a position of the lock member 12 against the bracket member 10.

Returning to FIG. 2, the bracket member 10 remains stationary while the lock 12 moves relative to it. Accordingly, the pins 50 of the illustrated embodiment are fixed in position, and the elongate slot 48 of the lock 12 moves about the pins 50. Movement of the lock 12 to an unlocking position, away from the supports, stops when one end 56 (FIG. 1) of the elongate slot 48 contacts the distal pin. Movement of the lock 12 to a locked position, toward the supports, stops when an opposite end 58 of the slot 48 contacts the proximal pin. The pins 50 extend along a generally horizontal pane and guide movement of the lock 12 toward and away from the slot 14 formed in the upright. It should be appreciated that any number of pins may be used.

In another contemplated embodiment, the pins 50 can move in relation to a stationary elongate slot 48. In this embodiment, the elongate slot 48 can be formed in the bracket member 10 and the pins 50 can extend outwardly from the lock 12. No limitation is made herein concerning a mechanism for sliding the moveable lock 12 in relation to the bracket member 10.

FIGS. 1-3 and 5 further illustrate a handle portion 60 on the bracket assembly A. The handle portion 60 includes a tab 62 oriented generally transverse to a plane of the lock 12. The tab 62 is grasped for selectively sliding the lock 12 in relation to the bracket member 10. The tab 62 of the illustrated embodiment is formed at a terminal end of the body 20 situated farthest from the bracket teeth 34. However, there is no limitation made to a position of the tab 62 on the body 20.

In the unlocked position, the teeth 34 of the lock are situated generally in front of the bracket teeth 24, as shown in FIG. 2. To assemble the shelving system, the bracket tooth 34 is inserted through a select slot 14 until the first edge 36 generally contacts the upright 16. The bracket member 10 is then pushed downwardly to firmly seat the bracket tooth 24 in the slot 14. In this manner, an unoccupied space becomes available toward a top portion of the slot 14. Then, to lock the shelf in place, the tab 62 is used to selectively insert the lock tooth 34 into the slot 14 for occupying that available space. In order to unlock the shelf, the handle 60 is retracted until the lock teeth 34 clear the slots 14, 14′. At that point, the shelf can be lifted away from the supports 16 or 17.

With reference to FIGS. 3 and 4, the lock tooth 34 of the lock 12 is inserted into a shared slot 14 with the bracket tooth 24 of the bracket member 10. In the illustrated embodiment, corresponding sets of teeth 24, 34 of the bracket member 10 and the lock 12 are adapted to occupy shared slots 14′. The bracket tooth 24 is adapted to occupy a first portion 14a of the slot 14′. The lock tooth 34 is adapted to occupy a second portion 14b of the slot 14′. As mentioned, the bracket tooth 24 is more particularly adapted to contact the lower edge 28 of the shared slot 14. The lock tooth 34 is adapted to simultaneously contact the upper edge portion 46 of the shared slot 14. In this embodiment, the bracket and lock teeth 24, 34 are positioned in a side-by-side relationship. The bracket and lock teeth 24, 34 have a combined width approximating a lateral extent of the slot 14 in the upright 16. In one embodiment, each one of the bracket and lock teeth 24, 34 have widths approximating one-half of a lateral extent of the slot 14. However, it is contemplated that a first one of the bracket and lock teeth 24, 34 may include a width that is greater than a second one of the teeth.

It is further contemplated, that the bracket and lock teeth 24, 34 of the discussed embodiment may occupy different slots 14′, such as adjacent slots. If the bracket and lock teeth 24, 34 occupy different slots, their respective widths may approximate a lateral extent of the slot 14.

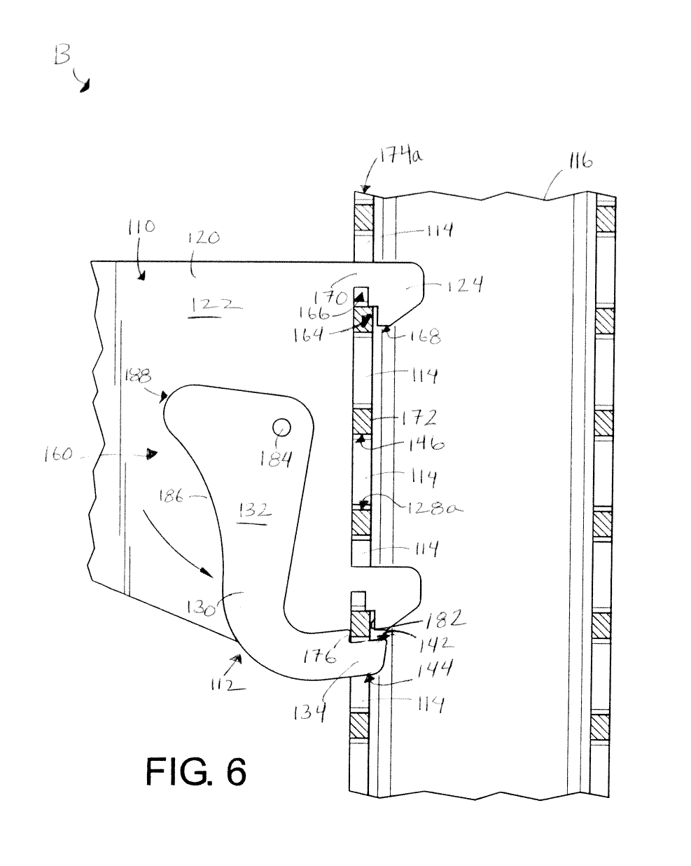

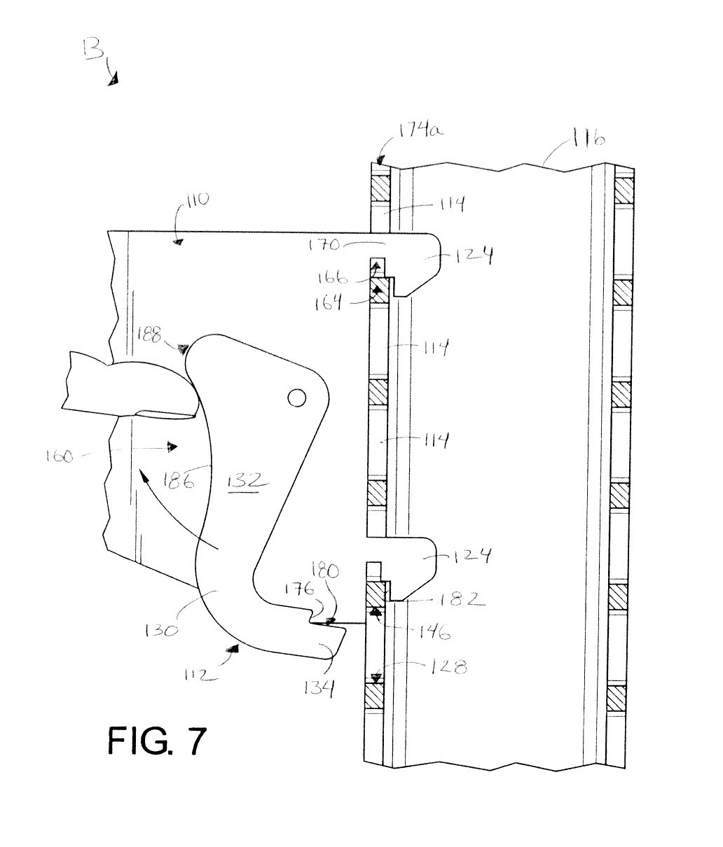

With reference to FIGS. 6 and 7, a second embodiment of a bracket assembly B is illustrated according to the disclosure. The second embodiment similarly includes a bracket member 110 and a lock 112. The bracket member 110 is illustrated to have a generally planar surface 122 portion included on a bracket body 120. The bracket member 110 further includes at least one tooth 124 extending outwardly from the body 120. FIGS. 6 and 7 include two spaced apart teeth 124 extending beyond a terminal edge 172 of the body 120.

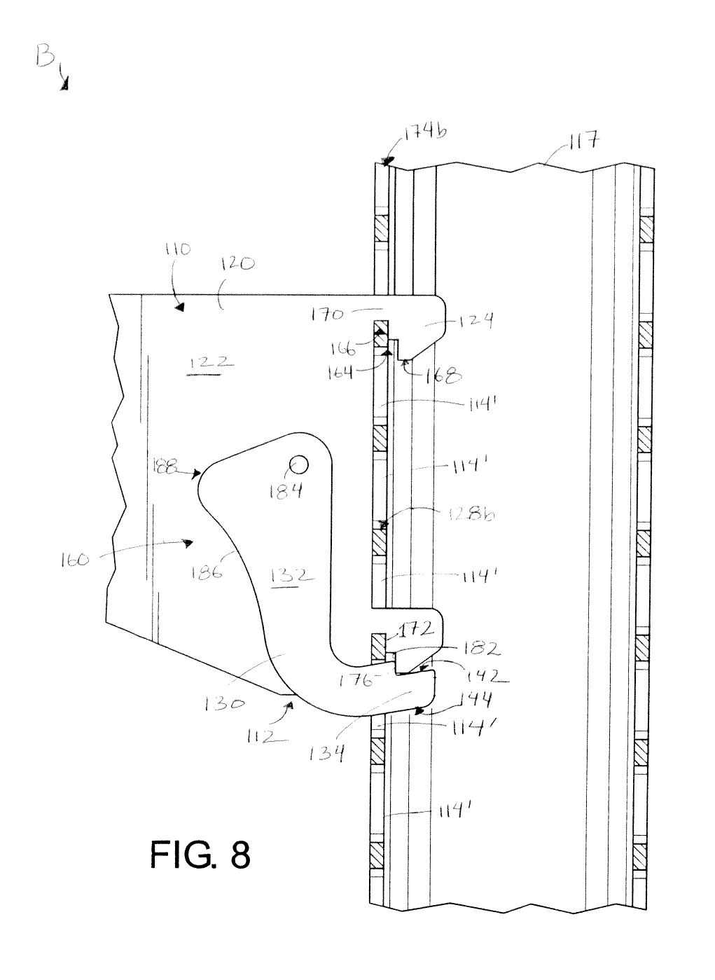

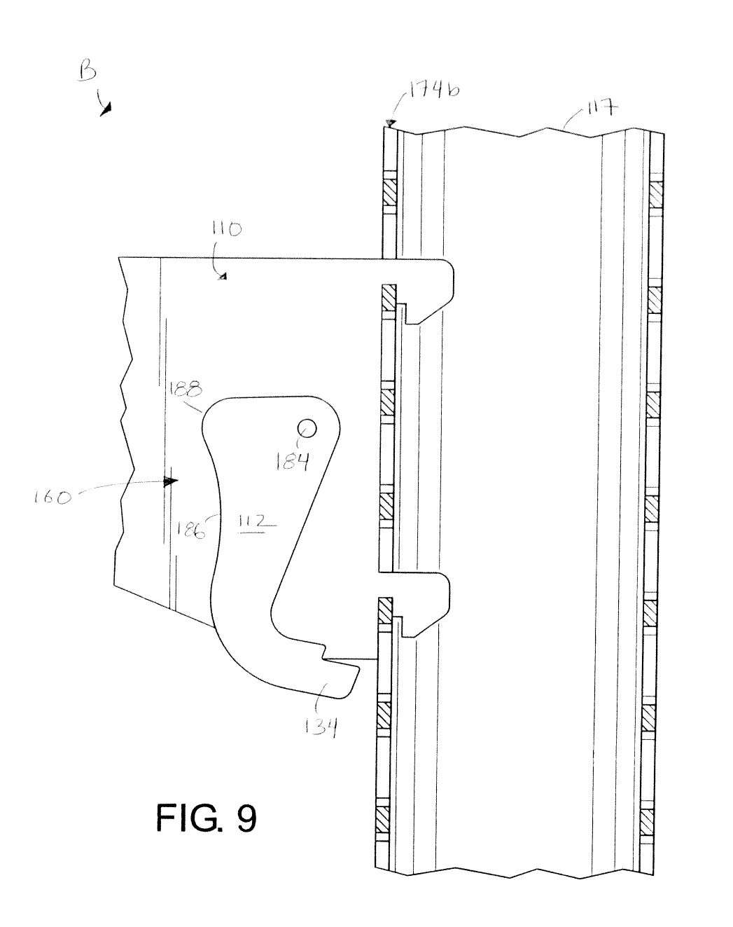

With continued reference to FIG. 6, each tooth 124 includes a hook- shaped projection. More particularly, this hook-shaped projection is formed from at least one notch in the tooth 124 body. A first notch 164 is formed where a lower edge 168 of the tooth 124 meets the terminal edge 172 of the body 120. In the illustrated embodiment, at least a second notch 166 is also formed in the tooth 124. The second notch 166 is formed where a root 170 of tooth, formed from the first notch 164, meets the terminal edge 172 of the body 120. The first notch 164 is wider than the second notch 166. Thus, the disclosed bracket assembly B is capable of being utilized with multiple types of uprights 116. More specifically, the lock 112 is capable of accommodating different shelving support members. The contemplated types of uprights, such as upright 116 (FIG. 6) and upright 117 (FIG. 8), include front walls having differing thicknesses. The first notch 164 can seat on a lower slot edge 128a formed by a wider upright wall 174a (see FIGS. 6 and 7) while the second notch 166 can seat on a lower slot edge 128b formed by a narrower upright wall 174b (see FIGS. 8 and 9). In other words, the first notch 164 is adapted to seat on an upright wall 174a having a first thickness and the second notch 166 is adapted to seat on a different upright wall having a second thickness, which can be less than the first thickness. Each of the first and second notches 164, 166 generally include a width dimension equivalent to a slot 114 depth.

With continued reference to FIG. 6, the lock 112 includes a locking body 130. The illustrated locking body 130 is a generally planar body. However, multiple shapes and geometries are contemplated. The locking body 130 similarly includes a generally planar surface 132. The generally planar surfaces 122, 132 of the bracket member 110 and the lock 112 are situated in adjacent relationship. The lock 112 further includes at least one lock tooth 134 extending outwardly from the lock body 132. The lock tooth 134 includes a length that extends beyond a depth of the slot 114 when the lock 112 is selectively placed in a locking position. The lock tooth 134 further includes a height that is less than a height of the slot 114.

With continued reference to FIG. 6, one aspect of the discussed embodiment is a design that firmly positions a tray on the shelving system. More particularly, the combination of the bracket tooth 124 and the lock tooth 134 prevent inward, outward, upward, and downward movements of the tray with applied forces. The tray is secure once both of the bracket member 110 and the lock 112 engage the upright 116. As can be viewed in FIG. 6, the first notch 164 of the bracket member 112 is defined by a set of edges that prevent inward, outward, and downward tray movements when the bracket assembly B is seated in the slot 114. Each edge defining the first notch 166 portion acts as a positive stop when it contacts adjacent portions of the upright wall 174a.

With continued reference to FIG. 6, the lock tooth 134 includes a top edge 142 and a bottom edge 144. The top edge 142 generally abuts an upper edge portion 146 of the slot 114 when the lock 112 is in a locked position. This top edge 142 acts as a positive stop when a force is applied upwardly to the tray. In this manner, the tray will not lift in reaction to the upwardly applied force.

Still referring to FIG. 6, the lock tooth 134 includes a contact surface 176 at a terminal end 178 of the lock body 130. The contact surface 176 is an edge that defines one wall of an inward step 180 formed in the body. The lock tooth 134 is formed from this inward step 180 (FIG. 7). The contact surface 176 abuts an outer oriented surface of the upright wall 174a when the lock 112 is in a locked position.

FIGS. 8 and 9 illustrate the discussed embodiment engaging a narrower upright wall 174b. The top edge 142 of the lock tooth 134 generally abuts a lower edge portion 168 of the bracket tooth 124 when the lock 112 is in a locked position. This contacting relationship prevents the tray 118 from lifting in reaction to the upwardly applied force. Furthermore, in the discussed embodiment of FIGS. 8 and 9, the contact surface 176 of the lock tooth 134 contacts a generally parallel first notch edge 182. The contact surface 176 can provide an indication that the lock 112 is suitably positioned in the slot 114 when it comes into contact with an adjacent surface.

A locking position for the bracket assembly B of FIGS. 6-9 includes the first bracket tooth 124 seated in a first slot 114, 114′ of the upright. The lock tooth 134 seats in a different slot 114, 114′ of the upright. More particularly, the lock tooth 134 seats in a slot that is adjacent to the one occupied by the bracket tooth 124. In embodiments including multiple, spaced apart bracket teeth 124 on the bracket member 110, the lock tooth 134 can seat in the slot 114, 114′ situated below a different slot which is occupied by the lowermost bracket tooth 124. However, embodiments are contemplated to include a lock tooth 134 that occupies at least one vacant slot situated between a pair of slots occupied by spaced apart bracket teeth 124.

With continued reference to FIGS. 6 and 8, the select slot that receives the lock tooth 134 can be based on a pivotal placement of the lock body 112 to the bracket member 110. A connector 184 is shown at a position on the bracket member 110 that allows the lock tooth 134 to extend beyond the lowest bracket tooth 124. Accordingly, pivotal movement of the lock tooth 134 can be directed toward the slot 114, 114′ that is situated beneath the closest unoccupied slot 114, 114′.

One aspect of the discussed embodiment is a bracket assembly B that is capable of selectively operating in the locked position (FIGS. 6 and 8) and the unlocked position (FIGS. 7 and 9). As mentioned, the lock 112 is pivotally mounted to the bracket member 110. A handle portion 160 is adapted to be moved for selectively pivoting the lock 112 about a pivot pin 184 in relation to the bracket member 110. More particularly, in this embodiment the handle portion 160 includes an arcuate section 186 formed on the lock 112. The arcuate section 186 forms an indentation in the lock 112 adapted to receive a finger.

The pivot pin 184 secures the lock 112 to the bracket member 110. It should be apparent from the location of the pivot pin 184 that the lock 112 is pivoted by gravity into its locked position and can be unlocked, as in FIGS. 7 AND 9 by a clockwise rotational movement around the pivot pin 184 as effected by a digit of the operator or user. Once unlocked, the shelf can be lifted up and removed from the support members 116 or 117.

With continued reference to FIG. 7, the arcuate section 186 can be situated along an outer edge portion of the lock 112. The edge portion can be oriented farthest from the associated upright 116 so that it is made easily accessible to a user. Furthermore, the arcuate section 186 can include a concave length, which forms the indentation. To operate the lock 112, a tail 188 of the arcuate section 186 can be used to urge the lock tooth 134 into and out of the slot 114. The user can urge movement of the lock 112 by applying force to the tail 188 in a generally upward direction. More particularly, the user can push upwardly against the lock 112 to remove the lock from the slot 114. In embodiments having an unbiased pivotal connection, the user can push forwardly against the lock 112 to urge the lock into the slot 114.

The present disclosure has been described with reference to several embodiments. Obviously, modifications and alterations will occur to others upon the reading and understanding the preceding detailed description. It is intended that the present disclosure be construed as including all such modifications and alterations in so far as they come within the scope of the appended claims or the equivalents thereof.

1. A bracket assembly for coupling an associated merchandise display member to an associated upright support member, comprising:
a bracket member including:
a first body having a first generally planar surface, and
a first tooth extending from the first body, the first tooth adapted to selectively seat in a slot in the associated upright support member; and,
a lock moveably mounted to the bracket member, including:
a second body having a second generally planar surface positioned adjacent the first planar surface,
a second tooth extending from the second body, the second tooth adapted to simultaneously seat in a slot in the associated upright support member, and
a handle portion for selectively moving the lock relative to the bracket member.

2. The bracket assembly of claim 1, wherein the first and second teeth are adapted to occupy a shared slot, wherein a top edge of the second tooth is adapted to function as a positive stop against a top edge of the shared slot such that the second tooth prevents the tray from moving in relation to the associated upright support member with an upwardly applied force.

3. The bracket assembly of claim 1, wherein the first tooth is adapted to contact a lower edge of a shared slot and the second tooth is adapted to contact an upper edge of the shared slot.

4. The bracket assembly of claim 1, wherein the lock is slideable in relation to the bracket member.

5. The bracket assembly of claim 1, wherein a first one of the bracket member and the lock includes an elongate slot adapted to act as a sliding track.

6. The bracket assembly of claim 5, wherein a second one of the bracket member and the lock includes a pin adapted to fit in the elongate slot for guiding a movement of the lock in relation to the bracket member.

7. The bracket assembly of claim 1, wherein the first tooth includes an inward step adapted to prevent the tray from moving away from the associated upright support member.

8. The bracket assembly of claim 1, wherein the handle portion includes a tab oriented generally transverse to a plane of the lock and being employed for selectively sliding the lock in relation to the bracket member.

9. The bracket assembly of claim 1, wherein the first and second teeth are adapted to occupy adjacent upright slots and wherein the second tooth is adapted to prevent an upwardly applied force from lifting the tray away from the associated upright support member.

10. The assembly of claim 1, wherein the lock is pivotally mounted to the bracket member.

11. The bracket assembly of claim 1, wherein the first tooth includes a first notch where the first tooth meets the first body, the second tooth includes a contact surface located at a terminal end of the second tooth.

12. The bracket assembly of claim 11, wherein the first tooth includes two notches, a first notch being wider than the second notch.

13. The bracket assembly of claim 11, wherein the contact surface of the second tooth is adapted to extend through the slot and contact the first tooth.

14. The bracket assembly of claim 1, wherein the handle portion includes an arcuate section adapted to be moved for selectively pivoting the lock in relation to the bracket member.

15. A bracket assembly for coupling a merchandise display member to an associated upright support member, comprising:
a bracket member including a first tooth adapted to occupy a first portion of a slot in the associated upright; and,
a lock adapted to move relative to the bracket member, the lock including a second tooth adapted to occupy a second portion of the slot in the associated upright;
wherein the first and second teeth seat respectively against opposed edges of the slot in the associated upright such that the first and second teeth prevent a removal of the merchandise display member from the associated upright.

16. The bracket assembly of claim 15, wherein the lock includes an elongate slot adapted to act as a sliding track and wherein the bracket member includes a pin adapted to fit in the elongate slot for guiding a sliding movement of the lock in relation to the bracket member.

17. The bracket assembly of claim 15, wherein the first and second teeth are positioned in a side-by-side relationship and have widths approximating one-half of a lateral extent of the slot in the associated upright.

18. The bracket assembly of claim 15, wherein the lock includes a tab oriented generally transverse to a plane of the lock, the tab acting as a handle for selectively sliding the lock in relation to the bracket member.

19. A bracket assembly for coupling a merchandise display member to an associated upright support member, comprising:
a bracket member including a first tooth extending outwardly from a first body, the first tooth including a first notch where the first tooth meets the first body; and,
a lock moveable relative to the bracket member, the lock including a second tooth extending outwardly from a second body, the second tooth including a contact surface at a terminal end of the second tooth;
wherein the first tooth occupies a first slot in the associated upright and the second tooth occupies a second adjacent slot in the associated upright, and wherein the second tooth is adapted to prevent lifting of the merchandise display member from the associated upright.

20. The bracket assembly of claim 19, wherein the first tooth includes two notches, a first notch being wider than a second notch.

21. The bracket assembly of claim 19, wherein the contact surface of the second tooth is adapted to extend through a second slot in the associated upright and contact the first tooth.

22. The bracket assembly of claim 19, wherein the lock includes a handle portion adapted to be moved for selectively pivoting the lock in relation to the bracket member.
